(19) United States
(12) Patent Application Publication
(10) Pub. No.: US 2026/0071807 A1
(43) Pub. Date: Mar. 12, 2026

(54) REFRIGERATOR

(71) Applicants: Xiaomi Technology (Wuhan) Co., Ltd., Wuhan (CN); Xiaomi Smart Appliances (Wuhan) Co., Ltd., Wuhan (CN); BEIJING XIAOMI MOBILE SOFTWARE CO., LTD., Beijing (CN)

(72) Inventor: Wei ZHANG, Wuhan (CN)

(21) Appl. No.: 19/277,962

(22) Filed: Jul. 23, 2025

(30) Foreign Application Priority Data
Sep. 12, 2024 (CN) 202411283448.9

(51) Int. Cl. F25D 23/02; E05D 11/06

(52) U.S. Cl. CPC F25D 23/028; E05D 11/06; E05Y 2900/31; F25D 2323/024

(57) ABSTRACT

A refrigerator includes: a cabinet having a plurality of accommodation spaces; a door used to cover an opening of each accommodation space; and a hinge assembly used to pivotally mount the door to the cabinet, the hinge assembly including a hinge seat, a mating seat, a first hinge shaft and a second hinge shaft, the first hinge shaft being arranged on the hinge seat, the mating seat being provided with a switching structure corresponding to the first hinge shaft, the hinge assembly having a first state and a second state switchable with each other. In the first state, the first hinge shaft is rotatably arranged within the switching structure to rotate the mating seat about the first hinge shaft; and in the second state, the first hinge shaft is slidably arranged within the switching structure, to rotate the mating seat about the second hinge shaft.

### CROSS-REFERENCE TO RELATED APPLICATION

The present application claims the benefit of priority to Chinese Application No. 202411283448.9, filed on Sep. 12, 2024, the content of which is incorporated herein by reference in its entirety for all purposes.

### FIELD

The present disclosure relates to the field of refrigerator technologies, and more particularly to a refrigerator.

### BACKGROUND

In related art, a hinge assembly is arranged between a cabinet and a door of a refrigerator to enable the opening and closing of the door. Currently, hinge assemblies are mostly single-axis structures, which causes a hinged side of the door to protrude excessively beyond the dimensions of the refrigerator during opening and closing, resulting in a serious protrusion phenomenon of the door.

### SUMMARY

In an aspect, embodiments of the present disclosure provide a refrigerator including: a cabinet, a door, and a hinge assembly. The cabinet has a plurality of accommodation spaces. The door is used to cover an opening of each accommodation space. The hinge assembly is used to pivotally mount the door to the cabinet. The hinge assembly includes a hinge seat, a mating seat, a first hinge shaft and a second hinge shaft. The first hinge shaft is arranged on the hinge seat, the mating seat is provided with a switching structure corresponding to the first hinge shaft, and the hinge assembly has a first state and a second state switchable with each other. In the first state, the first hinge shaft is rotatably arranged within the switching structure to rotate the mating seat about a central axis of the first hinge shaft; and in the second state, the first hinge shaft is slidably arranged within the switching structure to rotate the mating seat about a central axis of the second hinge shaft.

### BRIEF DESCRIPTION OF THE DRAWINGS

The accompanying drawings are used to provide further understanding of the present disclosure, and constitutes a part of the specification, and are intended to explain the present disclosure with the following specific implementations, but do not constitute a limitation to the present disclosure. In which:

FIG. 1 is a structural schematic diagram of a refrigerator provided by an embodiment of the present disclosure.

FIG. 2 is an enlarged view of portion A in FIG. 1.

FIG. 3 is an enlarged view of portion B in FIG. 1.

FIG. 4 is an enlarged view of portion C in FIG. 1.

FIG. 5 is a structural schematic diagram of a hinge assembly of the refrigerator in FIG. 2.

FIG. 6 is a structural schematic diagram of a hinge assembly of the refrigerator in FIG. 3.

FIG. 7 is a partial exploded view of a hinge assembly of the refrigerator in FIG. 6.

FIG. 8 is a structural schematic diagram of a hinge assembly of the refrigerator in FIG. 4.

FIG. 9 is an exploded view of a hinge assembly of the refrigerator in FIG. 8.

FIG. 10 is a partial exploded view of a hinge assembly of the refrigerator in FIG. 8.

FIG. 11 is a bottom view of a mating seat of a hinge assembly of the refrigerator in FIG. 8.

FIG. 12 is a partial sectional view of a hinge assembly of the refrigerator in FIG. 8.

FIG. 13 is a simplified schematic diagram of a hinge assembly of a refrigerator provided by an embodiment of the present disclosure, where the hinge assembly is in a first state, and the mating seat is in a closed position.

FIG. 14 is a simplified schematic diagram of a hinge assembly of a refrigerator provided by an embodiment of the present disclosure, where the hinge assembly is switched from a first state to a second state.

FIG. 15 is a simplified schematic diagram of a hinge assembly of a refrigerator provided by an embodiment of the present disclosure, where the hinge assembly is in a second state, and the mating seat is in a maximum opening position.

FIG. 16 is a simplified schematic diagram of a hinge assembly of a refrigerator provided by an embodiment of the present disclosure, where the hinge assembly is in a first state, a door is in a closed position.

FIG. 17 is a simplified schematic diagram of a refrigerator provided by an embodiment of the present disclosure, where the hinge assembly is switched from a first state to a second state.

FIG. 18 is a simplified schematic diagram of a hinge assembly of a refrigerator provided by an embodiment of the present disclosure, where the hinge assembly is in a second state, a door is in a maximum opening position.

### REFERENCE NUMERALS

1—hinge seat; 11—first limiting post; 12—second limiting post; 13—second limiting face; 2—mating seat; 21—mating hole; 3—first hinge shaft; 31—first face; 32—second face; 33—connecting edge; 4—second hinge shaft; 5—switching structure; 51—limiting portion; 511—communication port; 52—guiding portion; 521—first limiting face; 6—limiting bracket; 7—connecting rod; 71—first end; 72—second end; 81—washer; 82—radial flange; 9—leveling foot; 10—cabinet; 20—door; 201—outer end point; 30—hinge assembly.

### DETAILED DESCRIPTION OF THE DISCLOSURE

Specific embodiments of the present disclosure are described in detail below in conjunction with the accompanying drawings. It should be understood that, the specific embodiments described herein are merely used to illustrate and explain the present disclosure, and are not intended to limit the present disclosure.

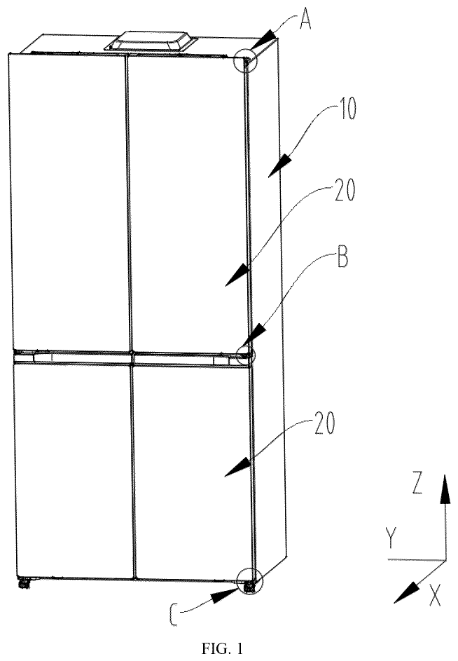

In the present disclosure, unless otherwise specified, the directional terms such as ‘front, rear, up, down, left, and right’ are defined based on the XYZ coordinate system shown in FIG. 1. The X direction represents the front-rear direction, with the side pointed to by the arrow being ‘front’ and the opposite side being ‘rear; the Y-direction represents the left-right direction; the Z-direction represents the up-down direction, with the side pointed to by the arrow being ‘up’ and the opposite side being ‘down’; the up-down direction may also be represented by the gravitational direction of a refrigerator or a hinge assembly. “Inner” and “outer” refer to the inner and outer relative to the contour of each component. The terms ‘first’ and ‘second’ are used to distinguish one element from another and do not imply order or importance. In addition, in the following description, when referring to the accompanying drawings, the same reference numerals in different drawings indicate the same or similar elements, and the present disclosure does not repeat them here.

According to some embodiments of the present disclosure, there is provided a refrigerator. As illustrated in FIGS. 1 to 4, the refrigerator may include a cabinet 10 and a door 20. The cabinet 10 may have an accommodation space with an opening on one side, and the number of the accommodation spaces may be a plurality. The door 20 may cover the opening of the accommodation space, and the number of the doors 20 may be a plurality. In some embodiments, each door 20 of the plurality of doors 20 may respectively cover each opening in the plurality of accommodation spaces, i.e., one door 20 may cover a corresponding opening; or the plurality of doors 20 may collectively cover the opening of the accommodation space, in which case the number of accommodation spaces is one; or the door 20 may cover the openings of the plurality of accommodation spaces, in which case the number of doors 20 is one, which is not limited by the present disclosure. In an embodiment, as illustrated in FIG. 1, two doors 20 arranged in the up-down direction may be provided on both the left and right sides of the cabinet 10. In other words, the refrigerator of the present disclosure may include four doors 20, which is not limited by the present disclosure.

In some embodiments, to facilitate the opening and closing of the door 20, the present disclosure provides a hinge assembly 30, and the hinge assembly 30 may be connected to both the door 20 and the cabinet 10, i.e., the hinge assembly 30 is arranged between the door 20 and the cabinet 10. The hinge assembly 30 is used to pivotally mount the door 20 to the cabinet 10. In some embodiments, as illustrated in FIGS. 1 to 4, the refrigerator may include a plurality of doors 20, each door 20 may have hinge assemblies 30 on both upper and lower sides, and two adjacent doors 20 in the up-down direction may share a hinge assembly 30. In other words, for two adjacent doors 20 in the up-down direction on the cabinet 10, an upper side of the door 20 arranged higher may have a hinge assembly 30, which may be referred to as a first hinge; a lower side of the door 20 arranged lower may have a hinge assembly 30, which may be referred to as a second hinge. In some embodiments, the second hinge may include a leveling foot 9 to facilitate leveling of the refrigerator. The two adjacent doors 20 in the up-down direction may share a hinge assembly 30, which may be referred to as a third hinge.

In some embodiments of the present disclosure, as illustrated in FIGS. 1 to 10, the hinge assembly 30 may include a hinge seat 1, a mating seat 2, a first hinge shaft 3, and a second hinge shaft 4. The first hinge shaft 3 and the second hinge shaft 4 are spaced apart, that is, a central axis of the first hinge shaft 3 is not in the same position as a central axis of the second hinge shaft 4. The central axis of the first hinge shaft 3 may be parallel to the central axis of the second hinge shaft 4, and the mating seat 2 is movably arranged on the hinge seat 1 through the first hinge shaft 3 and the second hinge shaft 4. The difference is that the hinge assembly 30, referred to as the third hinge, may include two mating seats 2, and the hinge seat 1 of the hinge assembly 30 is provided with two symmetrically arranged first hinge shafts 3 and two symmetrically arranged second hinge shafts 4. The first hinge shaft 3 and the second hinge shaft 4 on the same side may be spaced apart. Each mating seat 2 may be movably arranged on the hinge seat 1 through the first hinge shaft 3 and second hinge shaft 4 on the same side. One of the hinge seat 1 and the mating seat 2 may be connected to the cabinet 10, and the other of the hinge seat 1 and the mating seat 2 may be connected to the door 20. Thus, when the door 20 is opened or closed, the mating seat 2 and hinge seat 1 move relative to each other. Here, the present disclosure is illustrated by way of example using the hinge seat 1 connected to the cabinet 10 and the mating seat 2 connected to the door 20.

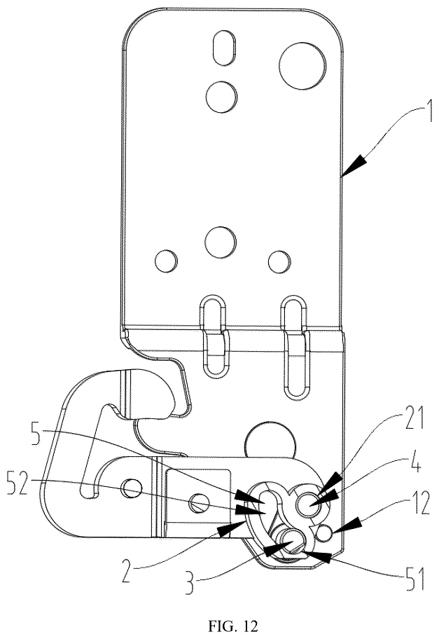

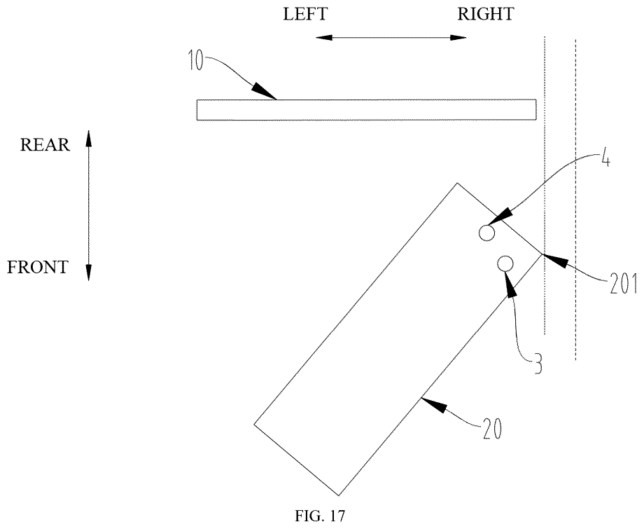

In some embodiments of the present disclosure, as illustrated in FIGS. 7 to 18, the hinge assembly 30 has a first state and a second state switchable to each other. In the first state, the mating seat 2 rotates about the central axis of the first hinge shaft 3; in the second state, the mating seat 2 rotates about the central axis of the second hinge shaft 4.

Through the above technical solution, in the hinge assembly 30 provided in the present disclosure, in a case where the mating seat 2 is connected to the door 20 and the hinge seat 1 is connected to the cabinet 10, when the door 20 is opened, the door 20 may gradually rotate from the closed position to the maximum opening position; and during this process, the hinge assembly 30 may switch from the first state to the second state. In the first state, the door 20 rotates about the central axis of the first hinge shaft 3 with the mating seat 2. In the second state, the door 20 rotates about the central axis of the second hinge shaft 4 with the mating seat 2. Here, when the door 20 rotates independently about the central axis of the first hinge shaft 3, an outer end point 201 of the door 20 has a first maximum protrusion distance; when the door 20 rotates independently about the central axis of the second hinge shaft 4, the outer end point 201 of the door 20 has a second maximum protrusion distance. By first rotating the mating seat 2 about the central axis of the first hinge shaft 3 and then rotating the mating seat 2 about the central axis of the second hinge shaft 4, the protrusion distance of the outer end point 201 of the door 20 may be made smaller than the larger of the first maximum protrusion distance and the second maximum protrusion distance. Thus, when the hinge assembly 30 of the present disclosure is applied to the refrigerator, the protrusion phenomenon of the door 20 may be reduced or even eliminated. Similarly, when the door 20 is opened, the door 20 may gradually rotate from the closed position to the maximum opening position; and during this process, the hinge assembly 30 may switch from the second state to the first state. By first rotating the mating seat 2 about the central axis of the second hinge shaft 4 and then rotating the mating seat 2 about the central axis of the first hinge shaft 3, the protrusion distance of the outer end point 201 of the door 20 may be made smaller than the larger of the first maximum protrusion distance and the second maximum protrusion distance.

It should be understood that, in actual use of the refrigerator, the user may open the door 20 to any position before the maximum opening position. During this process, the hinge assembly 30 may remain in the first state without switching to the second state, or the hinge assembly 30 may remain in the second state without switching to the first state. The present disclosure uses the former as an example for illustrative purposes.

Thus, in an embodiment of the present disclosure, the refrigerator includes the hinge assembly 30 described above, the refrigerator may be embedded into an indoor cabinet. Due to the configuration of the hinge assembly 30, the protrusion phenomenon of the door 20 may be reduced or even eliminated, allowing for a smaller gap between the refrigerator and a panel of the indoor cabinet or a wall. This enhances the user experience, and the refrigerator of the present disclosure may be constructed as a flush-in refrigerator. In some embodiments of the present disclosure, the protrusion distance of the door 20 of the present disclosure may not be greater than 5 mm, for example, it may be 2 mm, 4 mm, etc., which is not strictly limited by the present disclosure.

It should be noted that in some embodiments, when the door 20 is opened, when the door 20 first rotates about the central axis of the first hinge shaft 3, and the first maximum protrusion distance is greater than the second maximum protrusion distance, the matching seat 2 is configured such that before the protrusion distance of the outer end point 201 of the door 20 increases to the first maximum protrusion distance, the hinge assembly 30 switches to the second state. This reduces or even eliminates the protrusion phenomenon of the door 20 in this embodiment. Similarly, in some embodiments, when the door 20 is opened, when the door 20 first rotates about the central axis of the second hinge shaft 4, and the second maximum protrusion distance is greater than the first maximum protrusion distance, the matching seat 2 is configured such that before the protrusion distance of the outer end point 201 of the door 20 increases to the second maximum protrusion distance, the hinge assembly 30 switches to the first state. This reduces or even eliminates the protrusion phenomenon of the door 20 in this embodiment. In some embodiments, the first maximum protrusion distance may be less than the second maximum protrusion distance, and the door 20 may first rotate about the central axis of the first hinge shaft 3 and then rotate about the central axis of the second hinge shaft 4. In addition, the protrusion distance may be understood as a distance by which the outer end point 201 of door 20 protrudes beyond the refrigerator in the left-right direction during the rotation of door 20. It could be understood that the outer end point 201 is a point of the outermost edge of a hinged side of the door 20 in the closed position along the front-rear direction and the left-right direction, as illustrated in FIG. 16. Here, the protrusion distance of the door 20 of the present disclosure may be less than the smaller of the first maximum protrusion distance and the second maximum protrusion distance, or may be less than the larger of the first maximum protrusion distance and the second maximum protrusion distance, which is not strictly limited by the present disclosure.

It should also be noted that when the mating seat 2 moves relative to the hinge seat 1, the mating seat 2 rotates about either the central axis of the first hinge shaft 3 or the central axis of the second hinge shaft 4. In other words, in the first state, the hinge assembly 30 is configured to restrict the rotation of the mating seat 2 about the central axis of the second hinge shaft 4. In the second state, the hinge assembly 30 is configured to restrict the rotation of the mating seat 2 about the central axis of the first hinge shaft 3.

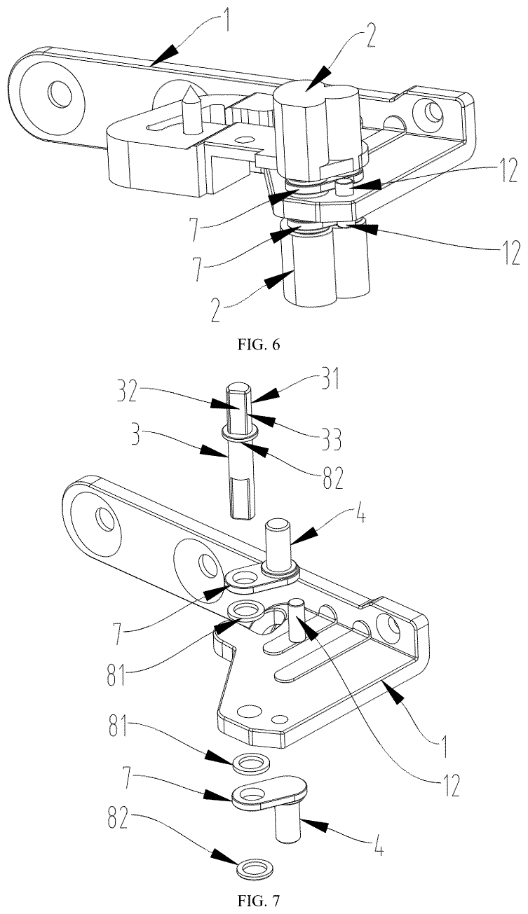

In some embodiments of the present disclosure, as illustrated in FIGS. 6 to 15, the first hinge shaft 3 may be arranged on one of the mating seat 2 and the hinge seat 1, and the switching structure 5 corresponding to the first hinge shaft 3 is arranged on the other of the mating seat 2 and the hinge seat 1. In the first state, the first hinge shaft 3 is rotatably arranged within the switching structure 5 to rotate the mating seat 2 about the central axis of the first hinge shaft 3; and in second state, first hinge shaft 3 is slidably arranged within the switching structure 5 to rotate the mating seat 2 about the central axis of the second hinge shaft 4. In this way, the switching structure 5 may be used to rotate the mating seat 2 about one of the central axis of the first hinge shaft 3 and the central axis of the second hinge shaft 4, enabling the hinge assembly 30 to switch between the first state and the second state. The first hinge shaft 3 is rotatably arranged within the switching structure 5, which may be understood as the first hinge shaft 3 rotating relative to the switching structure 5. The first hinge shaft 3 is slidably arranged within the switching structure 5, which may be understood as the first hinge shaft 3 sliding relative to the switching structure 5. In this way, the rotation of the mating seat 2 about the central axis of the second hinge shaft 4 may be achieved, and interference between the second hinge shaft 4 and the other of the mating seat 2 and the hinge seat 1 in the second state may be avoided.

In some embodiments of the present disclosure, the first hinge shaft 3 may be arranged on the hinge seat 1 to achieve relative rest between the first hinge shaft 3 and the hinge seat 1, for example, the first hinge shaft 3 may be fixedly connected to the hinge seat 1. When the hinge seat 1 is connected to the cabinet 10, the hinge seat 1, the first hinge shaft 3, and the cabinet 10 remain stationary; correspondingly, the switching structure 5 may be arranged on the mating seat 2 to achieve relative rest between the switching structure 5 and the mating seat 2, for example, the switching structure 5 may be formed on the mating seat 2. When the mating seat 2 is connected to the door 20, the mating seat 2, the switching structure 5, and the door 20 rotate synchronously. Here, the present disclosure is illustrated by way of example using the first hinge shaft 3 fixedly connected to the hinge seat 1 and the switching structure 5 formed on the mating seat 2.

In some embodiments of the present disclosure, as illustrated in FIGS. 6 to 15, the switching structure 5 may include a limiting portion 51 and a guiding portion 52 in communication with each other; in the first state, the first hinge shaft 3 is rotatably arranged within the limiting portion 51; and in the second state, the first hinge shaft 3 is slidably arranged within the guiding portion 52. Here, through the relative rotation of the first hinge shaft 3 and the limiting portion 51, the mating seat 2 may rotate about the central axis of the first hinge shaft 3; through the relative sliding of the first hinge shaft 3 and the guiding portion 52, the mating seat 2 may rotate about the central axis of the second hinge shaft 4. In other words, in the second state, the center of the circle corresponding to the guiding portion 52 aligns with the central axis of the second hinge shaft 4. Thus, by utilizing the relative sliding between the first hinge shaft 3 and the guiding portion 52, the guiding portion 52 may provide guidance for the mating seat 2, enhancing the smoothness of the door 20 during opening and closing. Here, in some embodiments, the guiding portion 52 may be constructed as an arc-shaped groove, and in this case, in the second state, a center of the circle corresponding to the arc-shaped groove aligns with the central axis of the second hinge shaft 4.

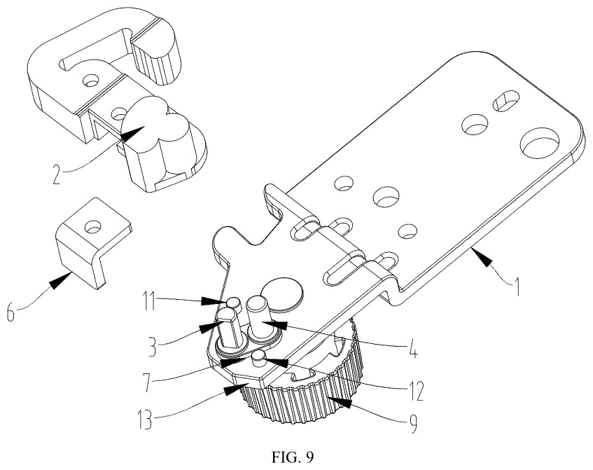

In some embodiments, as illustrated in FIGS. 9 to 15, the limiting portion 51 may have a communication port 511, and the communication port 511 is in communication with the guiding portion 52. When the hinge assembly 30 switches from the first state to the second state, the first hinge shaft 3 enters the guiding portion 52 through the communication port 511, enabling relative sliding between the first hinge shaft 3 and the guiding portion 52. In other words, in the first state, the hinge assembly 30 is configured to restrict the first hinge shaft 3 to only perform relative rotation with the limiting portion 51. The limiting portion 51 restricts the first hinge shaft 3 from entering the guiding portion 52 through the communication port 511, when the hinge assembly 30 switches from the first state to the second state, i.e., when the mating seat 2 rotates a predetermined angle relative to the hinge shaft, the hinge assembly 30 is configured to allow the first hinge shaft 3 to pass through the communication port 511 into the guiding portion 52. Thus, the hinge assembly 30 may switch from the first state to the second state.

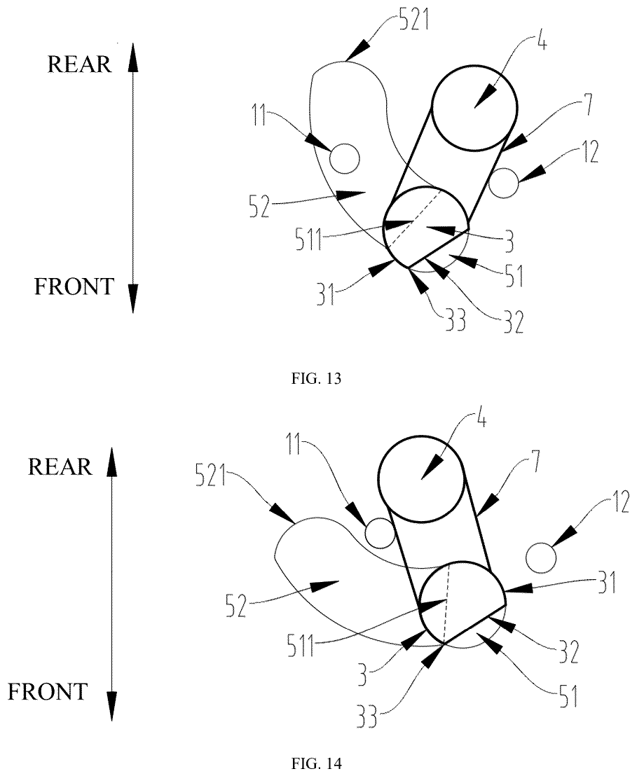

In some embodiments, as illustrated in FIGS. 9 to 15, the first hinge shaft 3 may have a first face 31 and a second face 32 connected to each other, one of the first face 31 and the second face 32 may be constructed as an arc-shaped surface to enable the first hinge shaft 3 to rotate relative to the limiting portion 51. The first face 31 and second face 32 form a connecting edge 33 at an intersection of the first face 31 and the second face 32; when the hinge assembly 30 switches from the first state to the second state, the connecting edge 33 may pass through the communication port 511, allowing the first hinge shaft 3 to enter the guiding portion 52 through the communication port 511. It can be understood that, as illustrated in FIGS. 13 and 14, in the first state, although the first hinge shaft 3 rotates relative to the limiting portion 51, the connecting edge 33 is restricted from passing through the communication port 511 into the guiding portion 52, restricting the first hinge shaft 3 within the limiting portion 51 and preventing it from entering the guiding portion 52 through the communication port 511. As illustrated in FIG. 14, when the hinge assembly 30 switches from the first state to the second state, the first hinge shaft 3 rotates relative to the limiting portion 51 until the connecting edge 33 enters the communication port 511. At this point, continuing to rotate the mating seat 2 allows the first hinge shaft 3 to enter the guiding portion 52 through the communication port 511. Thus, through the cooperation of the connecting edge 33 and the communication port 511, the first hinge shaft 3 may be presented from accidentally entering the guiding portion 52 in the first state, improving the smoothness and reliability of the door 20 during opening and closing, and ensuring that the hinge shaft assembly may smoothly switch from the first state to the second state.

In some embodiments, as illustrated in FIGS. 9 to 15, the limiting portion 51 may be constructed as a circular hole, so that, in the first state, the limiting portion 51 may rotate relative to the first hinge shaft 3. The guiding portion 52 may be constructed as an arc-shaped groove, the circular hole has the communication port 511 defined in one side of the circular hole in communication with the arc-shaped groove. Here, in the second state, the center of the circle corresponding to the arc-shaped groove aligns with the central axis of the second hinge shaft 4.

In an embodiment, as illustrated in FIGS. 11 to 15, the arc-shaped groove may have a width in its radial direction, and the width of the arc-shaped groove may be smaller than a diameter of the circular hole. Thus, in the first state, the second face 32 may be positioned away from the communication port 511. When the first hinge shaft 3 rotates relative to the circular hole, the first face 31 remains in contact with the communication port 511. The portion of the first hinge shaft 3 between the connecting edge 33 and the communication port 511 cannot pass through the communication port 511. This causes the first hinge shaft 3 to be stuck at the communication port 511 before the connecting edge 33 reaches the communication port 511, allowing it to only rotate relative to the circular hole and preventing it from entering the arc-shaped groove through the communication port 511. Therefore, setting the width of the arc-shaped groove to be smaller than the diameter of the circular hole may further prevent the first hinge shaft 3 from accidentally entering the guiding portion 52 in the first state. As illustrated in FIG. 14, when the hinge assembly 30 switches from the first state to the second state, the first hinge shaft 3 rotates relative to the circular hole until the connecting edge 33 just reaches the communication port 511, at this point, the second face 32 is located between the two arc-shaped surfaces of the arc-shaped groove. This configuration allows the entire first hinge shaft 3 to enter the arc-shaped groove through the communication port 511, ensuring that the hinge shaft assembly may smoothly switch from the first state to the second state.

In another embodiment, the hinge assembly 30 may further include a switching member. When the hinge assembly 30 switches from the first state to the second state, the switching member may be moved from restricting the first hinge shaft 3 from entering the guiding portion 52 to allowing the first hinge shaft 3 to enter the guiding portion 52. This ensures that the hinge shaft assembly smoothly switches from the first state to the second state. The switching member may be telescopically arranged on the hinge seat 1. In the first state, the switching member extends and is stopped on the first hinge shaft 3 to restrict the first hinge shaft 3 from entering the guiding portion 52. When the hinge assembly 30 switches from the first state to the second state, the switching member retracts, releasing the stop on the first hinge shaft 3 and allowing the first hinge shaft 3 to enter the guiding portion 52. In this embodiment, the width of the arc-shaped groove may be greater than or equal to the width of the circular hole.

In some embodiments, as illustrated in FIGS. 9 to 15, the first hinge shaft 3 may be constructed as a D-shaped shaft, and accordingly, the first face 31 may be constructed as an arc-shaped surface, and the second face 32 may be constructed as a flat surface. Of course, the first hinge shaft 3 may also be constructed as a special-shaped shaft other than a circular shaft, and the second face 32 may be constructed as a curved surface, a wavy surface, a stepped surface, etc. The present disclosure can be adapted as needed.

In some embodiments, as illustrated in FIGS. 9 to 15, the width of the communication port 511 may not be greater than the width of the guiding portion 52, i.e., the width of the communication port 511 is less than or equal to the width of the guiding portion 52. This enhances the smoothness of the door 20 during opening and closing, and prevents the first hinge shaft 3 from experiencing significant friction or becoming stuck within the guiding portion 52 when the width of the communication port 511 is greater than the width of the guiding portion 52.

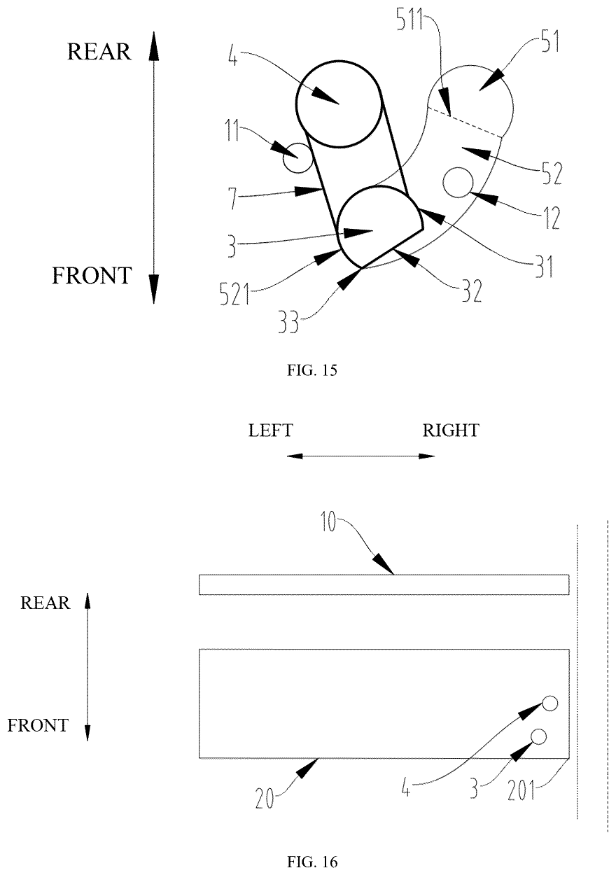

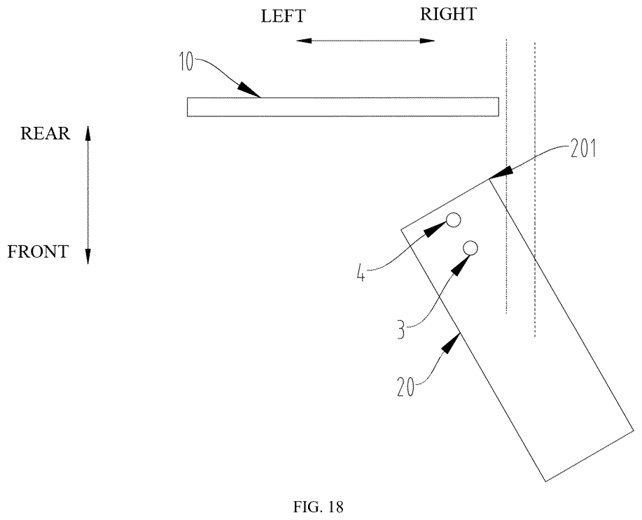

In some embodiments of the present disclosure, as illustrated in FIGS. 15 and 18, the guiding portion 52 is provided with a first limiting face 521 in a shape of a circular arc on a side away from the limiting portion 51, and in the second state, the mating seat 2 has a maximum opening position, and in the maximum opening position, the first hinge shaft 3 abuts against the first limiting face 521. Thus, by the contact between the first hinge shaft 3 and the first limiting face 521, the further rotation of the mating seat 2 is restricted, preventing the door 20 from opening excessively. At this point, when the door 20 is opened, the hinge assembly 30 sequentially switches from the first state to the second state.

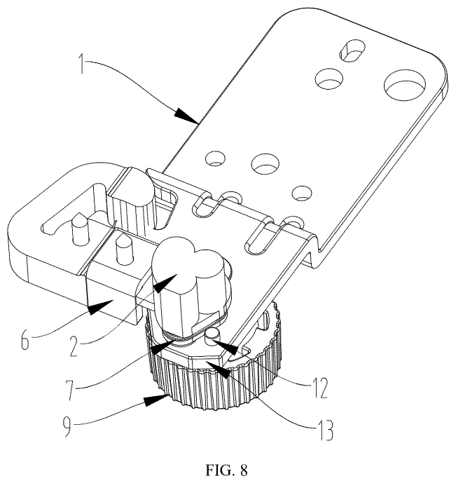

In some embodiments of the present disclosure, as illustrated in FIGS. 8 and 9, the hinge seat 1 may be provided with a second limiting face 13, the mating seat 2 may be provided with a limiting bracket 6, and in the second state, the mating seat 2 has a maximum opening position, and in the maximum opening position, the limiting bracket 6 abuts against the second limiting face 13. Thus, by the contact between the limiting bracket 6 and the second limiting face 13, the further rotation of the mating seat 2 is restricted, also preventing the door 20 from opening excessively. At this point, when the door 20 is opened, the hinge assembly 30 sequentially switches from the first state to the second state. In some embodiments, in the maximum opening position, the limiting bracket 6 may abut against the second limiting face 13, and the first hinge shaft 3 may abut against the first limiting face 521, improving the stability of the door 20 in the maximum opening position. In some examples, the limiting bracket 6 may be detachably connected to the mating seat 2. For example, the limiting bracket 6 may be connected to the mating seat 2 by a fastener, which facilitates the assembly and disassembly of the limiting bracket 6 and the mating seat 2. In some examples, the second limiting face 13 may be constructed as an inclined surface, i.e., arranged at an angle to the front-rear direction, which is not limited by the present disclosure.

In some embodiments of the present disclosure, as illustrated in FIGS. 6 to 18, the second hinge shaft 4 may be rotatably arranged on the hinge seat 1 about the central axis of the first hinge shaft 3. In the first state, the second hinge shaft 4 rotates with the mating seat 2 about the central axis of the first hinge shaft 3. This prevents interference between the mating seat 2 and the second hinge shaft 4 when the mating seat 2 rotates about the central axis of the first hinge shaft 3. Furthermore, by the synchronous rotation of the second hinge shaft 4 and the mating seat 2, the position of the second hinge axis 4 may be adjusted. Thus, when the hinge assembly 30 is in the second state, adjusting the position of the second hinge shaft 4 allows the mating seat 2 to rotate about the central axis of the second hinge axis 4, further reducing the protrusion distance of the door 20, and further reducing or even eliminating the protrusion phenomenon of the door 20.

In some embodiments of the present disclosure, as illustrated in FIGS. 8 to 15, the mating seat 2 may be provided with a mating hole 21 that is circular, the second hinge shaft 4 is inserted in the mating hole 21; and in the second state, the mating seat 2 is rotatable about the central axis of the second hinge shaft 4 through the mating hole 21. In this way, by utilizing the cooperation between the second hinge shaft 4 and the mating hole 21, the mating seat 2 may rotate synchronously with the second hinge shaft 4 about the central axis of the first hinge shaft 3 in the first state, and the mating seat 2 may rotate about the central axis of the second hinge shaft 4 through the mating hole 21 in the second state.

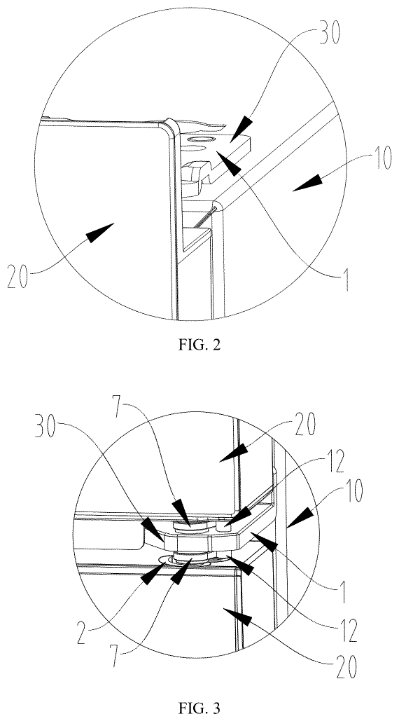

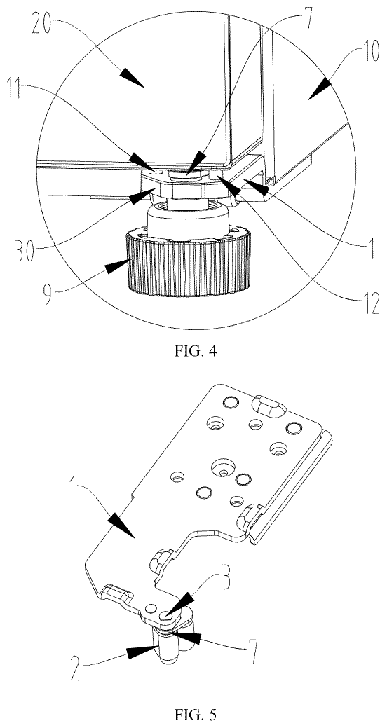

In some embodiments, as illustrated in FIGS. 3 to 10 and FIGS. 13 to 15, the hinge assembly 30 may include a connecting rod 7, the connecting rod 7 has a first end 71 and a second end 72 arranged oppositely, the first end 71 is rotatably fitted over the first hinge shaft 3, and the second end 72 is connected to the second hinge shaft 4. In this way, since the connecting rod 7 is fitted over the first hinge shaft 3, in the first state, the second hinge shaft 4 may drive the connecting rod 7 to rotate about the central axis of the first hinge shaft 3. Thus, the connecting rod 7 may provide guidance for the second hinge shaft 4, enabling the second hinge shaft 4 to rotate precisely about the central axis of the first hinge shaft 3. Of course, in some other embodiments, the hinge seat 1 may also define an arc-shaped guiding groove, and the second hinge shaft 4 is partially positioned within the guiding groove. The center of the circle of the guiding groove may align with the central axis of the first hinge shaft 3. In this way, in the first state, the guide groove may also provide guidance for the second hinge shaft 4. Here, the present disclosure is illustrated by way of example using the hinge assembly 30 including the connected rod 7.

In some embodiments, as illustrated in FIGS. 3 to 9, the connecting rod 7 and the hinge seat 1 may be spaced apart. This prevents friction between the connecting rod 7 and the hinge seat 1 when the mating seat 2 rotates, improving the smoothness of the mating seat 2 when rotating and improving the smoothness of the door 20 when opening and closing.

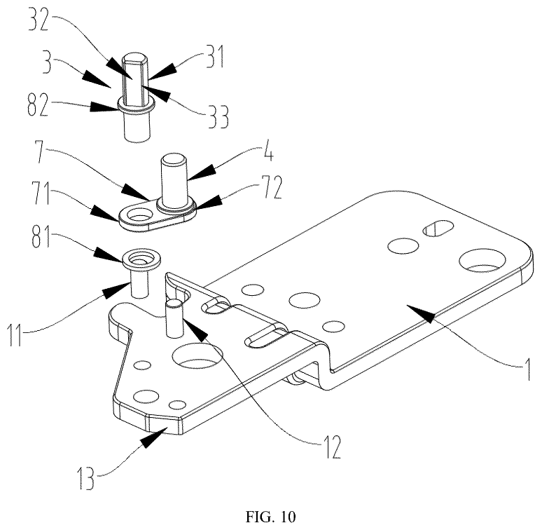

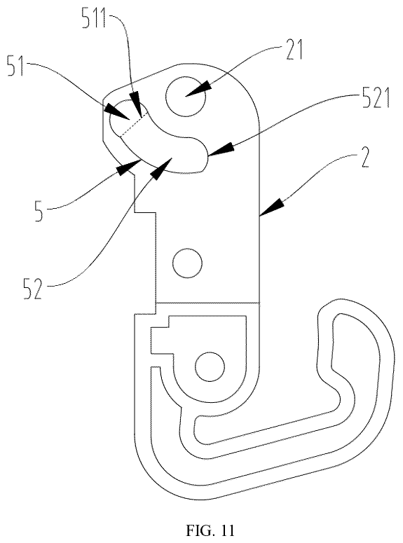

In some embodiments, as illustrated in FIGS. 7 and 10, the first hinge shaft 3 may be provided with a washer 81, the washer 81 abuts against the hinge seat 1, and the first end 71 is fitted over the first hinge shaft 3 and abuts against the washer 81. In this way, by arranging the washer 81 between the first end 71 of the connecting rod 7 and the hinge seat 1, the thickness of the washer 81 may be used to space the connecting rod 7 from the hinge seat 1, resulting in a simple structure that is easy to operate.

In some embodiments, as illustrated in FIGS. 7 and 10, the first hinge shaft 3 may be provided with a radial flange 82, and the first end 71 is arranged between the radial flange 82 and the washer 81. This prevents the first end 71 of the connecting rod 7 from shifting in the direction away from the washer 81, improving the reliability of the hinge assembly 30. Here, the radial flange 82 may be integrally formed with the first hinge shaft 3, of course, the radial flange 82 may also be detachably connected to the first hinge shaft 3, which is not limited by the present disclosure.

As illustrated in FIGS. 7 to 10, in the embodiment where the connecting rod 7 is spaced apart from the hinge seat 1, the second end 72 may have a first side and a second side arranged oppositely, the first side is farther from the hinge seat 1 than second side, and the second hinge shaft 4 may be connected to the first side. In this way, a gap may be created between the second hinge shaft 4 and the hinge seat 1, preventing friction between the second hinge shaft 4 and the hinge seat 1 when the mating seat 2 rotates. This improves the smoothness of the mating seat 2 when rotating, improving the smoothness of the door 20 when opening and closing.

In some embodiments, the second hinge shaft 4 may be integrally formed with the connecting rod 7. This eliminates the need for the connection step between the second hinge shaft 4 and the connecting rod 7, reduces the number of components in the hinge assembly 30, and facilitates the assembly of the hinge assembly 30. In some other embodiments, the second hinge shaft 4 may also be welded to the connecting rod 7 or connected in a detachable manner, which is not strictly limited in this disclosure.

In some embodiments, as illustrated in FIGS. 3, 4, 6 to 8 and 12 to 15, the hinge seat 1 may be provided with a second limiting post 12, in the second state, the connecting rod 7 and the second limiting post 12 are spaced apart; and in the first state, the mating seat 2 also has a closed position, and in the closed position, the connecting rod 7 abuts against the second limiting post 12. In this way, the contact between the connecting rod 7 and the second limiting post 12 may provide a closing stop for the door 20, preventing the door 20 from entering the accommodation space.

In some embodiments, as illustrated in FIGS. 9, 10, and 13 to 15, the hinge seat 1 may be provided with a first limiting post 11. The first limiting post 11 is configured to restrict the rotation of the second hinge shaft 4 about the central axis of the first hinge shaft 3, enabling the hinge assembly 30 to switch from the first state to the second state. In other words, when the hinge assembly 30 switches from the first state to the second state, the first limiting post 11 restricts the second hinge shaft 4 from continuing to rotate about the central axis of the first hinge shaft 3. This allows the mating seat 2 to continue to rotate about the central axis of the second hinge shaft 4, enabling the hinge assembly 30 to switch from the first state to the second state. In some embodiments, in a case where the connecting rod 7 is connected between the first hinge shaft 3 and the second hinge shaft 4, as illustrated in FIG. 14, when the hinge assembly 30 switches from the first state to the second state, the first limiting post 11 abuts against the second hinge shaft 4. In this case, the first limiting post 11 restricts the connecting rod 7 from continuing to rotate about the central axis of the first hinge shaft 3, enabling the hinge assembly 30 to switch from the first state to the second state.

In some embodiments of the present disclosure, as illustrated in FIGS. 13 to 18, in the first state, an angle between the door 20 and the cabinet 10 may be 0° to 50°; in the second state, the angle between the door 20 and the cabinet 10 may be 50° to 120°, so that the door 20 of the present disclosure may achieve a large angle of opening and closing. Of course, according to the needs, the angle between the door 20 and the cabinet 10 may be designed adaptively, which is not limited by the present disclosure.

In some embodiments of the present disclosure, as illustrated in FIGS. 13 to 18, the door 20 may be arranged at a front side of the cabinet 10, and the first hinge shaft 3 may be arranged at a front side of the second hinge shaft 4. In this way, since the door 20 first rotates about the central axis of the first hinge shaft 3 when opened, this configuration helps to reduce the protrusion distance of the door 20.

The following description provides a detailed explanation of the opening and closing process of the door 20 in conjunction with the aforementioned specific embodiments. As illustrated in FIGS. 13 to 18, when the door 20 is opened, the hinge assembly 30 first switches to the first state. Subsequently, the mating seat 2 rotates about the central axis of the first hinge shaft 3, causing the connecting rod 7 to disengage from the second limiting post 12. The connecting rod 7 then drives the second hinge shaft 4 to rotate synchronously with the mating seat 2. During this process, the first hinge shaft 3 is stuck within the limiting portion 51. The limiting portion 51, which is constructed as the circular hole, may only rotate relative to the first hinge shaft 3. When the door 20 rotates 50° relative to the cabinet 10, the first hinge shaft 3 rotates relative to the circular hole until the connecting edge 33 just reaches the communication port 511. At this point, the first hinge shaft 3 may enter the guiding portion 52 constructed as the arc-shaped groove through the communication port 511, and the connecting rod 7 abuts against the first limiting post 11, restricting the second hinge shaft 4 from continuing to rotate about the central axis of the first hinge shaft 3. Then, the door 20 continues to rotate, and the hinge assembly 30 switches from the first state to the second state. The arc-shaped groove slides relative to the first hinge shaft 3, causing the mating seat 2 to rotate about the central axis of the second hinge shaft 4. When the door 20 rotates 120° relative to the cabinet 10, the limiting bracket 6 abuts against the second limiting face 13, the first hinge shaft 3 abuts against the first limiting face 521, and in this case, the door 20 is in the maximum opening position.

When closing the door 20, simply perform the steps in reverse order of the above steps. In some examples, the hinge assembly 30 first switches to the second state, subsequently, the mating seat 2 rotates about the central axis of the second hinge shaft 4, causing the limiting bracket 6 to disengage from the second limiting face 13, and the first hinge shaft 3 to disengage from the first limiting face 521. The arc-shaped groove slides relative to the first hinge shaft 3. When the angle between the door 20 and the cabinet 10 is 50°, the connecting edge 33 reaches and subsequently passes through the communication port 511 to enter the limiting portion 51. Then, the door 20 continues to rotate, causing the hinge assembly 30 to switch to the first state. The connecting rod 7 drives the second hinge shaft 4 to rotate synchronously with the mating seat 2 about the central axis of the first hinge shaft 3. During this process, the first hinge shaft 3 is stuck within the limiting portion 51. The limiting portion 51 constructed as the circular hole may only rotate relative to the first hinge shaft 3, and the connecting rod 7 disengages from the first limiting post 11. When the angle between the door 20 and the cabinet 10 is 0°, the connecting rod 7 abuts against the second limiting post 12, and in this case, the door 20 is in the closed position.

The preferred embodiments of the present disclosure are described in detail above in conjunction with the accompanying drawings, however, the present disclosure is not limited to the specific details in the above embodiments, and a variety of simple variations of the technical solutions of the present disclosure may be carried out within the technical conception of the present disclosure, and all of these simple variations fall within the scope of protection of the present disclosure.

It should be noted that the specific technical features described in the above-mentioned specific embodiments may be combined in any appropriate manner without contradiction. In order to avoid unnecessary repetition, the present disclosure does not separately describe various possible combinations.

In addition, any combination between the various different embodiments of the present disclosure is also possible, and as long as they do not violate the ideas of the present disclosure, they should likewise be regarded as the contents disclosed in the present disclosure.

1. A refrigerator, comprising:
a cabinet having a plurality of accommodation spaces;
a door used to cover an opening of each accommodation space; and
a hinge assembly used to pivotally mount the door to the cabinet, the hinge assembly comprising a hinge seat, a mating seat, a first hinge shaft and a second hinge shaft, the first hinge shaft being arranged on the hinge seat, the mating seat being provided with a switching structure corresponding to the first hinge shaft, the hinge assembly having a first state and a second state switchable with each other,
wherein in the first state, the first hinge shaft is rotatably arranged within the switching structure to rotate the mating seat about a central axis of the first hinge shaft; and in the second state, the first hinge shaft is slidably arranged within the switching structure to rotate the mating seat about a central axis of the second hinge shaft.

2. The refrigerator according to claim 1, wherein the switching structure comprises a limiting portion and a guiding portion in communication with each other; in the first state, the first hinge shaft is rotatably arranged within the limiting portion; and in the second state, the first hinge shaft is slidably arranged within the guiding portion.

3. The refrigerator according to claim 2, wherein the limiting portion has a communication port, the communication port is in communication with the guiding portion, and when the hinge assembly is switched from the first state to the second state, the first hinge shaft enters the guiding portion through the communication port.

4. The refrigerator according to claim 3, wherein the first hinge shaft has a first face and a second face connected to each other, the first face and the second face form a connecting edge at an intersection of the first face and the second face, and when the hinge assembly is switched from the first state to the second state, the connecting edge can pass through the communication port, such that the first hinge shaft enters the guiding portion through the communication port.

5. The refrigerator according to claim 4, wherein the first hinge shaft is constructed as a D-shape shaft, the first face is constructed as an arc-shaped surface, and the second face is constructed as a flat surface.

6. The refrigerator according to claim 3, wherein a width of the communication port is not greater than a width of the guiding portion.

7. The refrigerator according to claim 2, wherein the limiting portion is constructed as a circular hole, the guiding portion is constructed as an arc-shaped groove, and the circular hole has a communication port defined in one side of the circular hole in communication with the arc-shaped groove.

8. The refrigerator according to claim 2, wherein the guiding portion is provided with a first limiting face in a shape of a circular arc on a side away from the limiting portion, and in the second state, the mating seat has a maximum opening position, and in the maximum opening position, the first hinge shaft abuts against the first limiting face.

9. The refrigerator according to claim 1, wherein the hinge seat is provided with a second limiting face, the mating seat is arranged with a limiting bracket, and in the second state, the mating seat has a maximum opening position, and in the maximum opening position, the limiting bracket abuts against the second limiting face.

10. The refrigerator according to claim 1, wherein the second hinge shaft is rotatably arranged on the hinge seat about the central axis of the first hinge shaft; and in the first state, the second hinge shaft rotates with the mating seat about the central axis of the first hinge shaft.

11. The refrigerator according to claim 10, wherein the hinge seat is provided with a first limiting post, the first limiting post is configured to restrict rotation of the second hinge shaft about a central axis of the first hinge shaft to switch the hinge assembly from the first state to the second state.

12. The refrigerator according to claim 10, wherein the mating seat is provided with a circular mating hole, the second hinge shaft is inserted in the circular mating hole; and in the second state, the mating seat is rotatable about the central axis of the second hinge shaft through the circular mating hole.

13. The refrigerator according to claim 12, wherein the hinge assembly comprises a connecting rod, the connecting rod has a first end and a second end arranged oppositely, the first end is rotatably fitted over the first hinge shaft, and the second end is connected to the second hinge shaft.

14. The refrigerator according to claim 13, wherein the connecting rod and the hinge seat are spaced apart.

15. The refrigerator according to claim 14, wherein the first hinge shaft is provided with a washer, the washer abuts against the hinge seat, and the first end is fitted over the first hinge shaft and abuts against the washer.

16. The refrigerator according to claim 15, wherein the first hinge shaft is provided with a radial flange, and the first end is arranged between the radial flange and the washer.

17. The refrigerator according to claim 14, wherein the second end has a first side and a second side arranged oppositely, the first side is farther from the hinge seat than the second side, and the second hinge shaft is connected to the first side.

18. The refrigerator according to claim 13, wherein the second hinge shaft and the connecting rod are integrally formed.

19. The refrigerator according to claim 13, wherein the hinge seat is provided with a second limiting post, in the second state, the connecting rod and the second limiting post are spaced apart; and in the first state, the mating seat has a closed position, and in the closed position, the connecting rod abuts against the second limiting post.

20. The refrigerator according to claim 1, wherein one of the hinge seat and the mating seat is connected to the cabinet and the other of the hinge seat and the mating seat is connected to the door.
